(19) United States
(12) Patent Application Publication
(10) Pub. No.: US 2015/0251425 A1
(43) Pub. Date: Sep. 10, 2015

(54) THROUGH-HOLE FORMING METHOD, MEMBER, INK JET HEAD, INK JET HEAD UNIT, AND INK JET RECORDING APPARATUS

(71) Applicant: SEIKO EPSON CORPORATION, Tokyo (JP)

(72) Inventor: Yutaka YAMAZAKI, Shiojiri-shi (JP)

(21) Appl. No.: 14/639,914

(22) Filed: Mar. 5, 2015

(30) Foreign Application Priority Data
Mar. 6, 2014 (JP) 2014-044426

(51) Int. Cl. B41J 2/16

(52) U.S. Cl. CPC B41J 2/1626; B41J 2/162

(57) ABSTRACT

A through-hole forming method includes applying etching and laser machining to a substrate to form a through-hole.

### BACKGROUND

1. Technical Field

The present invention relates to a through-hole forming method, a member, an ink jet head, an ink jet head unit, and an ink jet recording apparatus.

2. Related Art

For example, a through-hole is provided in constituent members of an ink jet head such as a nozzle plate and a communication plate.

In the past, such a through-hole is formed by etching (see, for example, JP-A-2011-121218 (Patent Literature 1).

However, when the through-hole is formed by etching, there is a problem in that, even when the thickness of a member to be etched is about several hundred micrometers, the etching is inferior in productivity because, for example, the etching requires several hours or more.

### SUMMARY

An advantage of some aspects of the invention is to provide a through-hole forming method with which a through-hole having a desired shape can be efficiently formed in a substrate, to provide a member in which the through-hole having the desired shape is formed, and to provide an ink jet head, an ink jet head unit, and an ink jet recording apparatus including the member in which the through-hole having the desired shape is formed.

The invention can be implemented as the following aspects.

An aspect of the invention is directed to a through-hole forming method including applying etching and laser machining to a substrate to form a through-hole.

With this configuration, it is possible to provide the through-hole forming method with which a through-hole having a desired shape can be efficiently formed in the substrate.

In the through-hole forming method according to the aspect of the invention, it is preferable that the substrate is formed of a crystalline material having etching anisotropy.

With this configuration, in the etching, it is possible to anisotropically etch the substrate. It is possible to more easily and surely form the through-hole having the desired shape.

In the through-hole forming method according to the aspect of the invention, it is preferable that the thickness of the substrate is equal to or larger than 100 μm and equal to or smaller than 1000 μm.

In the past, it is particularly difficult to efficiently form the through-hole having the desired shape in the substrate having such thickness. However, according to the aspect of the invention with this configuration, it is possible to efficiently form the through-hole having the desired shape even in the substrate having such thickness. That is, if the thickness of the substrate is a value in the range described above, the effect of the aspect of the invention is more conspicuously exhibited.

In the through-hole forming method according to the aspect of the invention, it is preferable that the width of the through-hole is equal to or larger than 10 μm and equal to or smaller than 50 μm.

In the past, when it is attempted to form the through-hole having such relatively small width, it is particularly difficult to efficiently form the through-hole as the through-hole having the desired shape. According to the aspect of the invention with this configuration, it is possible to efficiently form even the through-hole having such width as the through-hole having the desired shape. That is, if the width of the through-hole is a value in the range described above, the effect of the aspect of the invention is more conspicuously exhibited.

In the through-hole forming method according to the aspect of the invention, it is preferable that an aspect ratio, which is a ratio (D/W) of thickness D of the substrate to width W of the through-hole, is equal to or higher than 7 and equal to or lower than 20.

In the past, when it is attempted to form a through-hole having a relatively large aspect ratio in this way, it is particularly difficult to efficiently form the through-hole as the through-hole having the desired shape. However, according to the aspect of the invention with this configuration, it is possible to efficiently form even the through-hole having such an aspect ratio as the through-hole having the desired shape. That is, if the aspect ratio of the through-hole is a value within the range described above, the effect of the aspect of invention is more conspicuously exhibited.

Another aspect of the invention is directed to a member including the through-hole formed using the method according to the aspect of the invention.

With this configuration, it is possible to provide the member in which the through-hole having the desired shape is formed.

It is preferable that the member according to the aspect of the invention is an ink jet head component.

An ink jet head has a microstructure and includes a narrow ink channel such as a nozzle. In such an ink jet head, a slight difference in the shape or the size of a through-hole of a component greatly affects a discharge characteristic of droplets. In the aspect of the invention, it is possible to control a fine shape and the like and easily and surely form a through-hole having a desired shape and desired size. Therefore, when the aspect of the invention is applied to a component configuring the ink jet head (an ink jet head component), the effect of the aspect of the invention is more conspicuously exhibited.

Still another aspect of the invention is directed to an ink jet head manufactured using the member according to the aspect of the invention.

With this configuration, it is possible to provide the ink jet head including the member in which the through-hole having the desired shape is formed.

Yet another aspect of the invention is directed to an ink jet heat unit including the ink jet head according to the aspect of the invention.

With this configuration, it is possible to provide the ink jet head unit including the member in which the through-hole having the desired shape is formed.

Still yet another aspect of the invention is directed to an ink jet recording apparatus including the ink jet head unit according to the aspect.

With this configuration, it is possible to provide the ink jet recording apparatus including the member in which the through-hole having the desired shape is formed.

### BRIEF DESCRIPTION OF THE DRAWINGS

The invention will be described with reference to the accompanying drawings, wherein like numbers reference like elements.

FIGS. 1A to 1G are sectional views schematically showing a preferred embodiment of a through-hole forming method according to the invention.

FIG. 2 is a sectional view schematically showing a preferred embodiment of an ink jet head according to the invention.

FIG. 3 is a sectional view schematically showing another preferred embodiment of the ink jet head according to the invention.

FIG. 4 is a bottom view of a case of the ink jet head shown in FIG. 3.

FIG. 5 is a schematic diagram showing a preferred embodiment of an ink jet recording apparatus according to the invention.

### DESCRIPTION OF EXEMPLARY EMBODIMENTS

Preferred embodiments of the invention are explained in detail below with reference to the accompanying drawings.

### Through-Hole Forming Method

First, a through-hole forming method according to the invention is explained.

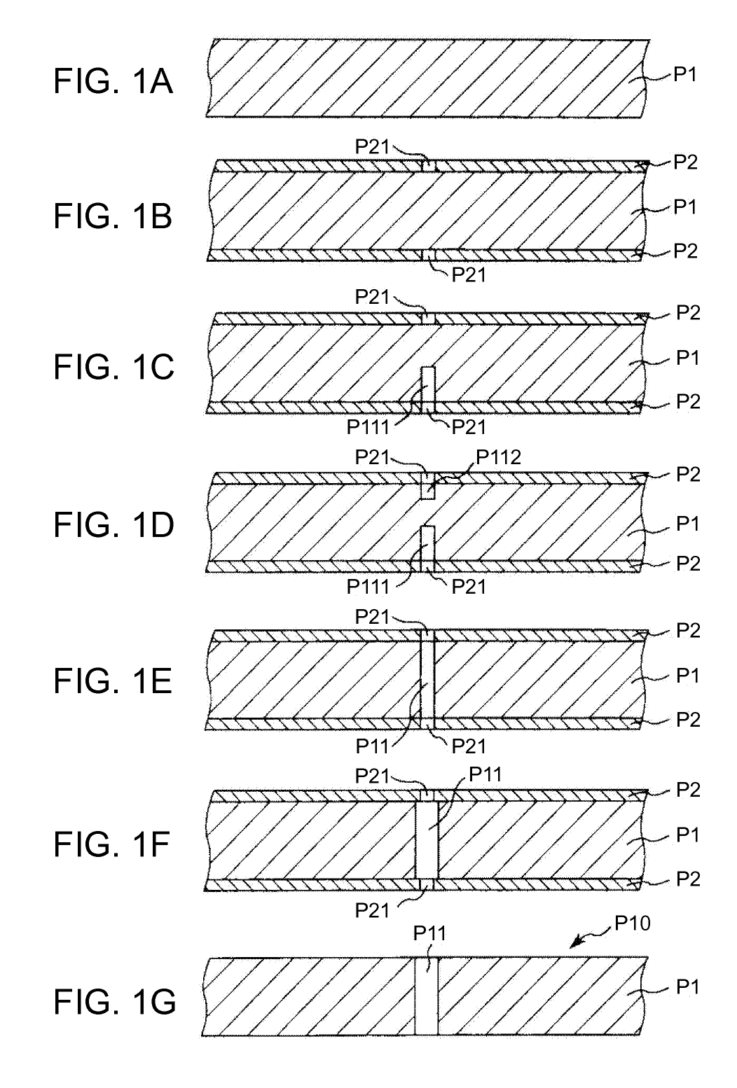

FIGS. 1A to 1G are sectional views schematically showing a preferred embodiment of a through-hole forming method according to the invention.

As shown in FIGS. 1A to 1G, the method according to this embodiment includes a substrate preparing step (1a) for preparing a substrate P1, a mask forming step (1b) for providing a mask P2 on the substrate P1, an etching step (a recessed section forming step) (1c) for applying etching to the substrate P1 on which the mask P2 is provided and forming a first recessed section P111, a laser machining step (a through-hole forming step) (1d, 1e) for applying laser machining to the substrate P1 on which the first recessed section P111 is formed, forming a second recessed section P112, further performing the laser machining to thereby cause the first recessed section P111 and the second recessed section P112 to communicate with each other, and forming a through-hole P11, a shape adjusting step (1f) for adjusting the shape of the through-hole P11, and a mask removing step (1g) for removing the mask P2.

### Substrate Preparing Step

First, the substrate P1 is prepared (1a).

The substrate P1 may be formed of any material. However, the substrate P1 is preferably formed of a crystalline material having etching anisotropy.

Consequently, in the etching step, it is possible to anisotropically etch the substrate P1. It is possible to more easily and surely form the through-hole P11 having a desired shape.

Note that, in this specification, “etching anisotropy” means a characteristic that etching speed in a predetermined direction is different from etching speed in another direction.

Examples of a material having etching anisotropy include silicon and quartz. However, the material having etching anisotropy is preferably silica.

Consequently, it is possible to more easily and surely form the through-hole P11 having higher accuracy and more surely prevented from being unintentionally bent.

The thickness of the substrate P1 (the thickness of a part where the through-hole P11 should be formed) is not particularly limited but is preferably equal to or larger than 100 μm and equal to or smaller than 800 μm.

In the past, it is particularly difficult to efficiently form a through-hole having a desired shape in the substrate having such thickness. However, in the invention, it is possible to efficiently form the through-hole having the desired shape even in the substrate having such thickness. That is, if the thickness of the substrate is a value within the range described above, the effect in the invention is more conspicuously exhibited.

### Mask Forming Step

The mask P2 is provided on the substrate P1 (1b).

As the mask P2, a mask including an opening section P21 is used.

The mask P2 can be formed by, for example, coating both the surfaces of the substrate P1 with film formation using a mask material such as a resist material and thereafter providing an opening section with treatment such as exposure and development.

For example, when the substrate P1 is formed of silicon or the like, the mask P2 may be formed by oxidizing the surface of the substrate P1. In this case, the formation of the opening section P21 (selective removal of a part of an oxide film) can be performed by, for example, irradiation of a laser beam.

### Etching Step

Subsequently, etching treatment (etching) is applied to the substrate P1 coated with the mask P2 (1c).

Consequently, the first recessed section P111 is formed on the substrate P1.

As the etching treatment, any one of dry etching or wet etching may be adopted. Two or more kinds of etching conditions may be used together. However, the etching treatment is preferably the dry etching.

Consequently, even if the opening section P21 is small, it is possible to suitably advance the etching. Even if the first recessed section P111 to be formed is relatively deep, it is possible to suitably form the first recessed section P111.

As an etching gas used for the dry etching, depending on a type of the substrate P1, for example, SF₆ (sulfur hexafluoride) can be suitably used.

When SF₆ is used, for example, a mixed gas of SF₆ and O₂ can also be used.

Consequently, it is possible to improve an etching rate. It is possible to obtain particularly excellent productivity of a target member P10 (the member P10 having the through-hole P11).

As a system of the dry etching, for example, etching by inductively coupled plasma can be suitably adopted.

As specific conditions of the etching, conditions explained below are preferable.

A flow rate of SF₆ is preferably equal to or larger than 200 sccm and equal to or smaller than 700 sccm.

A flow rate of O₂ is preferably equal to or larger than 20 sccm and equal to or smaller than 70 sccm.

Lower electrode power is preferably equal to or larger than 1500 W and equal to or smaller than 4000 W.

In this step, protective film formation (deposition) treatment and the etching treatment may be alternately performed.

For the protective film formation, as a treatment gas, for example, a mixed gas of C₄F₈ and O₂ can be used.

A flow rate of C₄F₈ during the protective film formation is preferably equal to or larger than 80 sccm and equal to or smaller than 400 sccm.

A flow rate of O₂ during the protective film formation is preferably equal to or larger than 8 sccm and equal to or smaller than 40 sccm.

Upper electrode power during the protective film formation is preferably equal to or larger than 700 W and equal to or smaller than 2500 W.

In this step, when the protective film formation (deposition) treatment and the etching treatment are alternately performed, it is preferable that a treatment time per one protective film formation (deposition) treatment is preferably equal to or longer than 3 seconds and equal to or shorter than 20 seconds. A treatment time per one etching treatment is preferably equal to or longer than 5 seconds and equal to or shorter than 30 seconds.

In this step, the first recessed section P111 is formed not to pierce through the substrate P1 in the thickness direction thereof.

The depth of the first recessed section P111 formed in this step is preferably equal to or larger than 40 μm and equal to or smaller than 560 μm.

Consequently, it is possible to form the second recessed section P112 to be formed in the laser machining step relatively shallow while reducing time required for the formation of the through-hole P11. It is possible to more surely prevent occurrence of a hole bend phenomenon in the laser machining step. It is possible to more surely form the through-hole P11 having the desired shape.

The depth of the first recessed section P111 formed in this step is preferably equal to or larger than 40% and equal to or smaller than 70% of the thickness of the substrate P1.

Consequently, it is possible to form the second recessed section P112 to be formed in the laser machining step relatively shallow while reducing time required for the formation of the through-hole P11. It is possible to surely prevent occurrence of the hole bend phenomenon in the laser machining step. It is possible to more surely form the through-hole P11 having the desired shape.

The width of the opening section of the first recessed section P111 formed in this step is preferably equal to or larger than 5 μm and equal to or smaller than 30 μm.

Consequently, it is possible to surely form the final through-hole P11 as a through-hole having sufficiently small width and a desired shape.

### Laser Machining Step

Subsequently, laser machining is applied to the substrate P1, on which the first recessed section P111 is formed, from a surface side opposite to a surface on which the first recessed section P111 is formed (1d, 1e).

Consequently, first, the second recessed section P112 is formed (1d). Thereafter, when the laser machining advances, the first recessed section P111 and the second recessed section P112 communicate with each other. The through-hole P11 is formed (1e).

By performing the etching and the laser machining in combination in this way, it is possible to efficiently form the through-hole P11 having the desired shape in a relatively short time.

On the other hand, when only one of the etching and the laser machining is used, such an excellent effect is not obtained.

That is, when a through-hole is formed by performing the etching and not performing the laser machining, since formation of the through-hole takes an extremely long time, productivity of a member including the through-hole is extremely low. In particular, such a problem more conspicuously occurs when the width of the through-hole to be formed is small, when the depth of the through-hole to be formed is large (when the thickness of the substrate is large), or when an aspect ratio of the through-hole (the ratio (D/W) of the thickness D of the substrate to the width W of the though-hole) is large.

When the through-hole is formed by performing the etching and not performing the laser machining or when a through-hole is formed in a relatively large substrate such as a wafer (a step for cutting out slices may be included after the formation of the through-hole according to necessity), the behavior of the etching is often different in the center portion and the vicinity of edges of a principal plane of the wafer. Therefore, for example, when it is attempted to form the through-hole in the substrate having relatively large thickness explained above only with the etching, an unintended bend or the like of the through-hole easily occurs.

When the through-hole is formed by performing the laser machining and not performing the etching, it is difficult to form the through-hole having the desired shape. This is considered to be because, when a recessed section is formed by the laser machining, foreign matters due to thermal modification accumulate in the formed recessed section and rectilinearity of the laser beam is hindered by the foreign matters or non-uniform thermal modification is further facilitated by absorption of energy of the laser beam in a thermally modified section.

In particular, as in this embodiment, by performing the laser machining after the etching, it is possible to more effectively prevent occurrence of the problem due to the thermal modification in the laser machining. It is possible to more surely form the through-hole P11 having the desired shape. By performing, with irradiation of the laser beam, treatment for causing the recessed sections (the first recessed section P111 and the second recessed section P112) by the laser beam to communicate with each other and forming the through-hole P11 in the substrate P1, it is possible to effectively prevent foreign matters from remaining on the inside (the wall surface) of the through-hole P11.

In the invention, the etching and the laser machining may be performed from the same surface side of the substrate. However, in this embodiment, the etching and the laser machining are performed on the opposite surfaces.

Consequently, even when the thickness of the substrate P1 is relatively large, it is possible to more surely perform selectively irradiation of the laser beam on a target part of the substrate P1. It is possible to more surely form the through-hole P11 having the desired shape.

Examples of the laser that can be used in this step include, for example, a YAG laser (in particular, a third harmonic wave (355 nm) or a fourth harmonic wave (266 nm)), a YVO₄ laser, and a YLF laser. Among the lasers, it is preferable to use an ultraviolet laser such as the YAG laser (in particular, a third harmonic wave (355 nm) or the fourth harmonic wave (266 nm)).

Consequently, absorption efficiency with respect to a material is improved. It is possible to suitably form the second recessed section P112 and the through-hole P11 with small input energy. As a result, it is possible to further reduce a range of a thermal effect on surroundings.

### Shape Adjusting Step

Subsequently, the shape of the through-hole P11 is adjusted (1f).

Consequently, it is possible to adjust the shape of the through-hole P11 to a more preferred shape.

The adjustment of the shape of the through-hole P11 can be performed by, for example, anisotropic etching.

For example, when the substrate P1 is formed of silicon, the anisotropic etching is preferably wet etching performed using a KOH solution.

The width of the through-hole P11 formed as explained above is preferably equal to or larger than 10 μm and equal to or smaller than 50 μm.

In the past, when it is attempted to form the through-hole having such relatively small width, it is particularly difficult to efficiently form the through-hole as the through-hole having the desired shape. In the invention, it is possible to efficiently form even the through-hole having such width as the through-hole having the desired shape. That is, if the width of the through-hole is a value in the range described above, the effect of the invention is more conspicuously exhibited.

It is preferable that an aspect ratio, which is a ratio (D/W) of thickness D of the substrate P1 to the width W of the through-hole P11, is equal to or higher than 7 and equal to or lower than 20.

In the past, when it is attempted to form the through-hole having a relatively large aspect ratio in this way, it is particularly difficult to efficiently form the through-hole as the through-hole having the desired shape. However, in the invention, it is possible to efficiently form even the through-hole having such an aspect ratio as the through-hole having the desired shape. That is, if the aspect ratio of the through-hole is a value within the range described above, the effect of the invention is more conspicuously exhibited. According to the invention, it is possible to inexpensively form even such a through-hole having the large aspect ratio.

### Mask Removing Step

Thereafter, the target member P10 (the member P10 including the through-hole P11) is obtained by removing the mask P2.

The removal of the mask P2 can be performed by a solution containing ammonium monohydrogen difluoride.

### Member Including a Through-Hole

A member (a member including a through-hole) according to the invention is explained.

The member according to the invention is a member including the through-hole formed using the method according to the invention explained above.

Consequently, it is possible to provide the member in which the through-hole having the desired shape is formed.

The member according to the invention may be any member. However, the member is preferably an ink jet head component.

An ink jet head has a microstructure and includes a narrow ink channel such as a nozzle. In such an ink jet head, a slight difference in the shape or the size of a through-hole of a component greatly affects a discharge characteristic of droplets.

In the invention, it is possible to control a fine shape and the like and easily and surely form a through-hole having a desired shape and desired size.

Therefore, when the invention is applied to a component configuring the ink jet head (an ink jet head component), the effect of the invention is more conspicuously exhibited. It is possible to provide the ink jet head excellent in reliability.

Examples of the ink jet head component including the through-hole include a nozzle plate and a communication plate.

### Ink Jet Head

An ink jet head according to the invention is explained.

The ink jet head according to the invention includes the ink jet head member functioning as the member according to the invention explained above.

Consequently, it is possible to attain excellent discharge stability of droplets from the ink jet head. It is possible to surely provide a finer through-hole in a desired shape, which is difficult in the past. Therefore, the inkjet head is advantageous in attaining improvement of nozzle density and an increase in the resolution of a printed image.

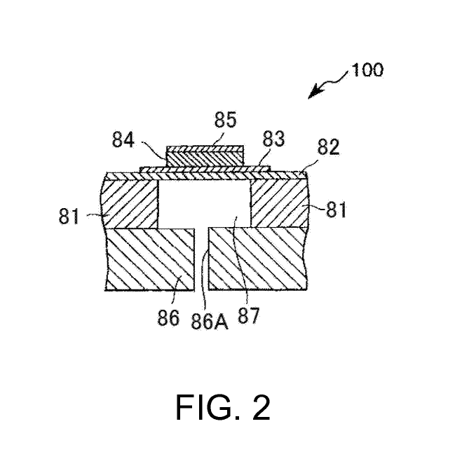

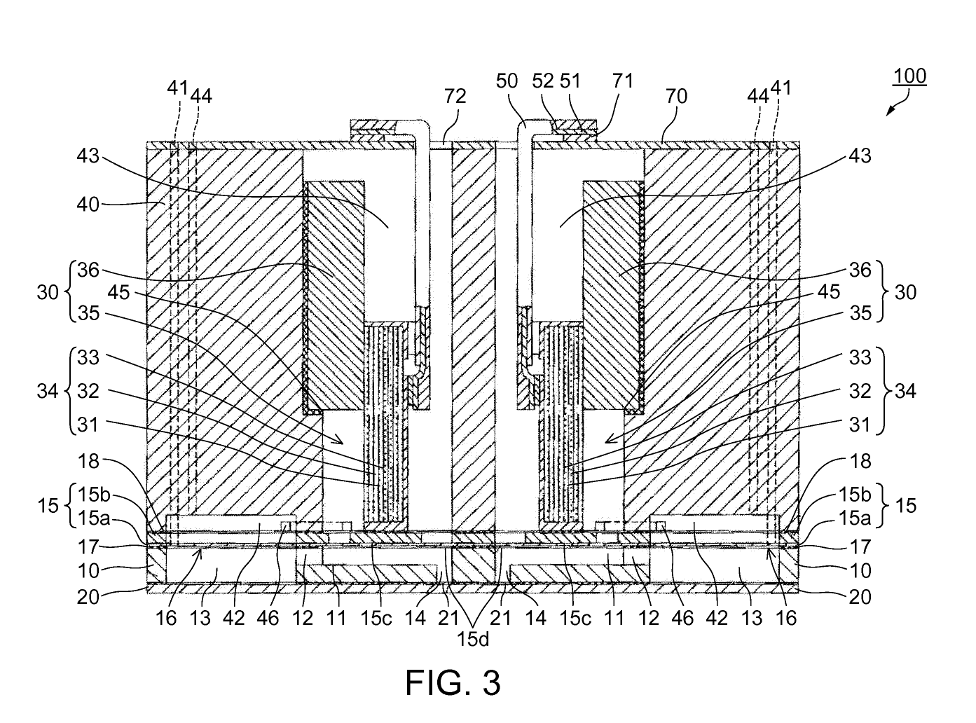

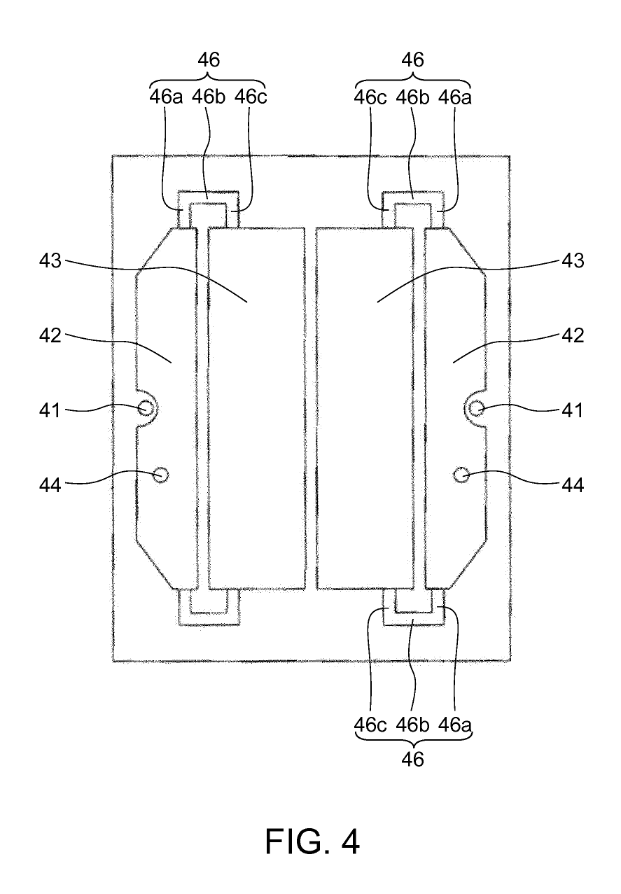

FIG. 2 is a sectional view schematically showing a preferred embodiment of the ink jet head according to the invention. FIG. 3 is a sectional view schematically showing another preferred embodiment of the ink jet head according to the invention. FIG. 4 is a bottom view of a case of the ink jet head shown in FIG. 3.

An ink jet head 100 shown in FIG. 2 includes a silicon substrate 81 in which an ink reservoir 87 is formed, a vibrating plate 82 formed on the silicon substrate 81, a lower electrode 83 formed in a predetermined position on the vibrating plate 82, a piezoelectric thin film 84 formed in a position corresponding to the ink reservoir 87 on the lower electrode 83, an upper electrode 85 formed on the piezoelectric thin film 84, and a second substrate 86 functioning as the member (the ink jet head component) according to the invention joined to the lower surface of the silicon substrate 81. In the second substrate 86, an ink ejection nozzle (a through-hole) 86A communicating with the ink reservoir 87 is provided.

In the ink jet head 100, ink is supplied to the ink reservoir 87 via a not-shown ink channel. When a voltage is applied to the piezoelectric thin film 84 via the lower electrode 83 and the upper electrode 85, the piezoelectric thin film 84 is deformed to decompress the ink reservoir 87 and apply pressure to the ink. The ink is ejected from the nozzle by the pressure to perform ink jet recording.

The ink jet head 100 can be, for example, an ink jet head having structure in which an Si thermal oxide film is formed as the vibrating plate 82, a thin-film piezoelectric element configured by the lower electrode 83, the piezoelectric thin film 84, and the upper electrode 85 is integrally molded on an upper part of the vibrating plate 82, and a chip consisting of the monocrystal silicon substrate 81, in which a cavity (the ink reservoir) 87 is formed, and a nozzle plate (the second substrate) 86 including the ink ejection nozzle 86A, which ejects the ink, are joined.

To secure larger displacement, in the piezoelectric thin film 84, for example, as a material having a high piezoelectric strain constant d31, a material formed of three-component-system PZT added with lead-magnesium niobate as a third component can be used. The thickness of the piezoelectric thin film 84 can be set to about 2 μm.

The ink jet head 100 shown in FIGS. 3 and 4 includes a channel forming substrate 10 including pressure generation chambers 11, a nozzle plate 20 functioning as the member (the ink jet head component) according to the invention in which a plurality of nozzles (through-holes) 21 communicating with the pressure generation chambers 11 are drilled, and a vibrating member 15 joined to the surface of the channel forming substrate 10 on the opposite side of the nozzle plate 20. Further, the ink jet head 100 in this embodiment includes piezoelectric element units 30 including a plurality of piezoelectric elements 35 provided in regions corresponding to the pressure generation chambers 11 on the vibrating member 15 and a case 40 joined to one surface of the channel forming substrate 10 via the vibrating member 15. In this embodiment, reservoirs 13 functioning as common liquid chambers of the pressure generation chambers 11 are formed in the channel forming substrate 10. The channel forming substrate 10 also functions as a reservoir forming substrate.

In the channel forming substrate 10, a plurality of the pressure generation chambers 11 are defined by partition walls and provided side by side in the width direction of the channel forming substrate 10 in a surface layer portion on one surface side of the channel forming substrate 10. Note that, in this embodiment, two rows each including the plurality of pressure generation chambers 11 provided side by side are formed. On each of the outer sides of the rows of the pressure generation chambers 11, one reservoir 13 to which the ink is supplied via an ink introducing path 41, which is a liquid introducing path of the case 40, is provided to pierce through the channel forming substrate 10 in the thickness direction.

The reservoirs 13 and the pressure generation chambers 11 communicate with each other via ink supply paths 12. The ink is supplied to the pressure generation chambers 11 via the ink introducing paths 41, the reservoirs 13, and the ink supply paths 12. In this embodiment, the ink supply paths 12 are formed in width smaller than the width of the pressure generation chambers 11. The ink supply paths 12 play a role of keeping fixed channel resistance of the ink flowing into the pressure generation chambers 11 from the reservoirs 13.

Further, on end sides of the pressure generation chambers 11 opposite to the reservoirs 13, nozzle communication holes (through-holes) 14 piercing through the channel forming substrate 10 functioning as the member (the ink jet head component) according to the invention are formed. That is, in this embodiment, the reservoirs 13, the ink supply paths 12, the pressure generation chambers 11, and the nozzle communication holes 14 are provided in the channel forming substrate 10 as liquid channels. The channel forming substrate 10 is configured by a silicon monocrystal substrate.

The nozzle plate 20, in which a plurality of the nozzles (through-holes) 21 for ejecting the ink are drilled, is joined to one surface of the channel forming substrate 10. The nozzles 21 communicate with the pressure generation chambers 11 via the nozzle communication holes (the through-holes) 14 provided in the channel forming substrate 10.

The vibrating member 15 is joined to the other surface of the channel forming substrate 10, that is, an opening surface of the pressure generation chambers 11 by an adhesive layer 17. The pressure generation chambers 11 are sealed by the vibrating member 15. Note that, as shown in the figure, the vibrating member 15 has an area substantially the same as the area of the other surface of the channel forming substrate 10 and is joined to cover the entire other surface of the channel forming substrate 10.

The vibrating member 15 is formed of a composite plate of an elastic film 15a made of an elastic member such as a resin film and a supporting plate 15b made of a metal material or the like that supports the elastic film 15a. The elastic film 15a side of the vibrating member 15 is joined to the channel forming substrate 10. In this embodiment, the elastic film 15a is made of a polyphenylene sulfide (PPS) film having thickness of about several micrometers. The supporting plate 15b is made of a stainless steel plate (SUS) having thickness of about several ten micrometers.

Regions of the vibrating member 15 opposed to circumferential edge portions of the pressure generation chambers 11 are thin sections 15d substantially configured by only the elastic film 15a with the supporting plate 15b removed therefrom. The thin sections 15d define one surfaces of the pressure generation chambers 11. On the inner sides of the thin sections 15d, island sections 15c consisting of parts of the supporting plate 15b in contact with the distal ends of the piezoelectric elements 35 are respectively provided. Regions of the vibrating member 15 opposed to the reservoirs 13 are vibrating sections 16 configured by only the elastic film 15a with the supporting plate 15b removed therefrom. When a pressure change occurs in the reservoirs 13, the vibrating sections 16 are deformed to absorb the pressure change to play a role of always keeping the pressure in the reservoirs 13 fixed. The case 40 is joined on the vibrating member 15 by an adhesive layer 18. That is, the case 40 in this embodiment is joined to the channel forming substrate 10 via the vibrating member 15.

In the case 40, as shown in FIG. 3, space sections 42 consisting of recessed sections are provided in positions opposed to the vibrating sections 16. The space sections 42 have height enough for not hindering the deformation of the vibrating sections 16. The space sections 42 communicate with an external space through case through-holes 44, which are atmosphere opening holes that pierce through the case 40 functioning as the member (the ink jet head component) according to the invention. Consequently, the pressure in the space sections 42 are always kept the same as the pressure of the external space. In the case 40, in positions opposed to the thin sections 15d, piezoelectric-element housing sections 43 consisting of piercing-through sections piercing through the case 40 are provided. Step sections 45 are provided on the ink introducing paths 41 sides of the piezoelectric-element housing sections 43. Fixed substrates 36 of the piezoelectric element units 30 explained below are joined to the step sections 45.

On the surface of the case 40 on the opposite side of the channel forming substrate 10 side, a wiring substrate 70, on which a plurality of conductive pads 71 respectively connected to wiring layers 51 of flexible printed boards 50 are provided, is fixed. On the wiring substrate 70, slit-like opening sections 72 are formed in regions opposed to the piezoelectric-element housing sections 43 of the case 40. The piezoelectric-element housing sections 43 communicate with the external space through the opening sections 72. The piezoelectric element units 30 including the piezoelectric elements 35 are housed in the piezoelectric housing sections 43.

The piezoelectric element units 30 are provided to be opposed to the pressure generation chambers 11. The piezoelectric element units 30 are configured by the plurality of piezoelectric elements 35 that vary the pressure in liquid channels including the pressure generation chambers 11 and the reservoirs 13 and the fixed substrates 36 that attach the piezoelectric elements 35 to the case 40.

In this embodiment, the piezoelectric elements 35 are integrally formed in one piezoelectric element unit 30. That is, piezoelectric-element forming members 34 are formed by alternately stacking piezoelectric materials 31 and electrode forming materials 32 and 33 a vertically long sandwich shape and are divided in a comb teeth shape to correspond to the pressure generation chambers 11, whereby the piezoelectric elements 35 are formed. That is, in this embodiment, the plurality of piezoelectric elements 35 are integrally formed. The distal end portions of the piezoelectric elements 35 are joined to the island sections 15c of the vibrating member 15 by an adhesive (a joining material). The piezoelectric elements 35 are firmly fixed to the fixed substrates 36 on the proximal end sides that are inactive regions not contributing to vibration. The fixed substrates 36, to which the piezoelectric elements 35 are firmly fixed in this way, are joined to the case 40 in the step sections 45 of the piezoelectric-element housing sections 43. Consequently, the piezoelectric element units 30 are housed in the piezoelectric-element housing sections 43 of the case 40 and fixed.

Note that the fixed substrates 36 are provided integrally with the piezoelectric elements 35 as explained above to configure the piezoelectric element units 30. The piezoelectric element units 30 are positioned and fixed in the case 40. In this case, positioning of the piezoelectric elements 35 with respect to the vibrating member 15 (the island sections 15c) is performed by the outer circumferential surfaces of the fixed substrates 36 and the inner surfaces of the piezoelectric-element housing sections 43. Consequently, it is possible to easily and highly accurately perform the positioning compared with directly gripping and positioning the piezoelectric elements 35, which are fragile materials.

The material configuring the fixed substrates 36 is not particularly limited. The fixed substrates 36 can be suitably configured by, for example, aluminum, copper, iron, and stainless steel. In the vicinities of the proximal end portions of the piezoelectric elements 35 of the piezoelectric element units 30, the flexible printed boards 50 including wiring layers 51, which supply signals for driving the piezoelectric elements 35, are connected to the surfaces on the opposite sides of the fixed substrates 36.

The flexible printed boards 50 consist of flexible printing circuits (FPC), tape carrier packages (TCP), and the like. More specifically, in the flexible printed boards 50, for example, the wiring layers 51 having a predetermined pattern are formed of copper thin film or the like on the surfaces of base films 52 of polyimide or the like and regions other than regions connected to other wires such as terminal sections connected to the piezoelectric elements 35 of the wiring layers 51 are covered with an insulating material such as resist.

The wiring layers 51 of the flexible printed boards 50 are connected to the electrode forming materials 32 and 33, which configure the piezoelectric elements 35, on proximal end portion sides of the wiring layers 51 by, for example, solder or an anisotropic conductive material.

On the other hand, on the distal end portion sides, the wiring layers 51 are electrically connected to conductive pads 71 of a wiring substrate 70 provided on the case 40. The flexible printed boards 50 are drawn out to the outer side of the piezoelectric-element housing sections 43 from opening sections 72 of the wiring substrate 70. Drawn-out regions are bent and connected to the conductive pads 71.

In the ink jet head 100 in this embodiment, as shown in FIG. 4, the piezoelectric-element housing sections 43 and the space sections 42 communicate with each other through communication paths 46.

The communication paths 46 are passages through which the piezoelectric-element housing sections 43 and the space sections 42 communicate with each other. In this embodiment, the communication paths 46 are formed on the bottom surface of the case 40 by removing a part of the surface on the cannel forming substrate 40 side of the case 40.

In this embodiment, the communication paths 46 are provided in positions not overlapping channels including the pressure generation chambers 11 in a stacking direction of the channel forming substrate 10, the vibrating member 15, and the case 40. Specifically, the communication paths 46 are provided in regions further on the outer sides than both end portions of the space sections 42 and the piezoelectric-element housing sections 43 in a juxtaposing direction of the pressure generation chambers 11.

The communication paths 46 are configured by first communication sections 46a contiguous to the space sections 42 and extending to the outer side along the juxtaposing direction of the pressure generation chambers 11 from the longitudinal direction end portions of the space sections 42, second communication sections 46b contiguous to the first communication sections 46a and extending along the longitudinal direction of the pressure generation chambers 11, and third communication sections 46c contiguous to the second communication sections 46b, extending to the inner side along the juxtaposing direction of the pressure generation chambers 11, and contiguous to the piezoelectric-element housing sections 43. The piezoelectric-element housing sections 43 and the space sections 42 communicate with each other through the communication paths 46. In this embodiment, the communication paths 46 are formed on the surface on the channel forming substrate 10 side of the case 40. That is, the communication paths 46 are provided as recessed sections on the surface on the channel forming substrate 10 side of the case 40.

Since the communication paths 46 are provided, the piezoelectric-element housing sections 43 and the space sections 42 configure channels through which the air flows. A volatile gas in the space sections 42 is relatively easily discharged to the external space.

In the ink jet head 100, the capacities of the pressure generation chambers 11 are changed by the deformation of the piezoelectric elements 35 and the vibrating member 15 to eject ink droplets from the nozzles 21. Specifically, when the ink is supplied to the reservoirs 13 via the ink introducing paths 41, which are liquid introducing paths, from not-shown liquid storing means, the ink is distributed to the pressure generation chambers 11 via the ink supply paths 12. A voltage is applied to a predetermined piezoelectric element 35 and the application of the voltage is released according to a driving signal from a not-shown driving circuit, whereby the piezoelectric element 35 is contracted and expanded to cause a pressure change in the pressure generation chambers 11 and eject the ink from the nozzles 21.

The invention can be applied to the component (the component including the through-hole) configuring the inkjet head explained above.

### Ink Jet Head Unit and Ink Jet Recording Apparatus

An ink jet head unit and an ink jet recording apparatus according to the invention are explained.

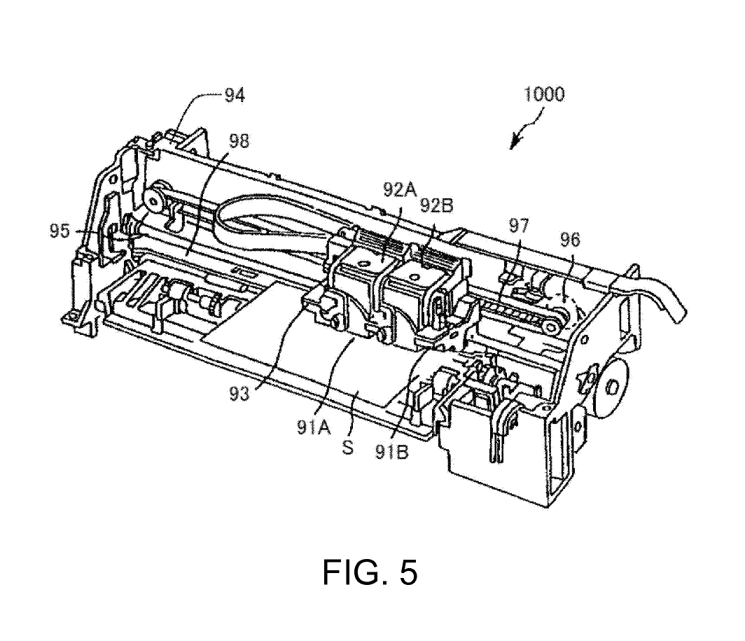

FIG. 5 is a schematic diagram showing a preferred embodiment of the ink jet recording apparatus according to the invention.

As shown in FIG. 5, an ink jet recording apparatus 1000 includes ink jet head units (recording head units) 91A and 91B, cartridges 92A and 92B, a carriage 93, an apparatus main body 94, a carriage shaft 95, a driving motor 96, a timing belt 97, and a platen 98.

In the recording head units 91A and 91B including the ink jet heads (the recording heads) according to the invention explained above, the cartridges 92A and 92B configuring ink supply means are detachably provided. The carriage 93 mounted with the recording head units 91A and 91B is provided in the carriage shaft 95, which is attached to the apparatus main body 94, to be movable in the axial direction. The recording head units 91A and 91B can be recording head units that respectively eject, for example, a black ink composition and a color ink composition.

A driving force of the driving motor 96 is transmitted to the carriage 93 via a not-shown plurality of gears and the timing belt 97, whereby the carriage 93 mounted with the recording head units 91A and 91B is moved along the carriage shaft 95. On the other hand, the platen 98 is provided in the apparatus main body 94 along the carriage shaft 95. A recording sheet S, which is a recording medium such as paper, fed by a not-shown paper feeding roller is wound around the platen 98 and conveyed.

The preferred embodiments of the invention are explained above. However, the invention is not limited to the preferred embodiments.

For example, in the through-hole forming method according to the invention, the order of the steps does not have to be the order explained above. For example, in the embodiment explained above, the through-hole forming method is explained as including the mask removing step after the shape adjusting step. However, the shape adjusting step may be performed after the mask removing step.

In the embodiment explained above, the through-hole forming method is explained as including the shape adjusting step and the mask removing step. However, the through-hole forming method according to the invention only has to be a method of at least applying the etching and the laser machining to form a through-hole and does not have to include the other steps.

In the configuration shown in the figure, the opening sections are provided in the masks provided on the surface on the opposite side of the side of the substrate where the first recessed section is formed. However, the opening sections do not have to be provided.

In the explanation in the embodiment explained above, the etching and the laser machining for recessed section formation are applied to the different surface sides of the substrate. However, the etching and the laser machining may be applied to the same surface side of the substrate.

In the through-hole forming method according to the invention, a pre-treatment process, an intermediate treatment process, and a post treatment process may be performed according to necessity.

In the embodiment explained above, the through-hole configuring the channel is mainly explained. However, the through-hole does not have to configure the channel.

In the above explanation, the ink jet head component is representatively explained as the member including the through-hole. However, the member (the member including the through-hole) according to the invention may be a member other than the ink jet head component. For example, the invention can also be suitably applied to, for example, an MEMS and an optical element. Since the MEMS, the optical element, and the like also have microstructures, the effect by the application of the invention is conspicuously exhibited.

The invention can also be suitably applied to a medical connector that connects medical tubes configuring an extracorporeal circulation circuit and an infusion circuit, a puncture needle such as an injection needle, a medical device such as a catheter, medical equipment, and the like.

The entire disclosure of Japanese Patent Application No. 2014-044426, filed Mar. 6, 2014 is expressly incorporated by reference herein.

What is claimed is:

1. A through-hole forming method comprising applying etching and laser machining to a substrate to form a through-hole.

2. The through-hole forming method according to claim 1, wherein the substrate is formed of a crystalline material having etching anisotropy.

3. The through-hole forming method according to claim 1, wherein thickness of the substrate is equal to or larger than 100 μm and equal to or smaller than 1000 μm.

4. The through-hole forming method according claim 1, wherein width of the through-hole is equal to or larger than 10 μm and equal to or smaller than 50 μm.

5. The through-hole forming method according to claim 1, wherein an aspect ratio, which is a ratio (D/W) of thickness D of the substrate to width W of the through-hole, is equal to or higher than 7 and equal to or lower than 20.

6. A member comprising the through-hole formed using the method according to claim 1.

7. A member comprising the through-hole formed using the method according to claim 2.

8. A member comprising the through-hole formed using the method according to claim 3.

9. The member according to claim 6, wherein the member including the through-hole is an ink jet head component.

10. The member according to claim 7, wherein the member including the through-hole is an ink jet head component.

11. The member according to claim 8, wherein the member including the through-hole is an ink jet head component.

12. An ink jet head manufactured using the member according to claim 9.

13. An ink jet head manufactured using the member according to claim 10.

14. An ink jet head manufactured using the member according to claim 11.

15. An ink jet heat unit comprising the ink jet head according to claim 12.

16. An ink jet heat unit comprising the ink jet head according to claim 13.

17. An ink jet heat unit comprising the ink jet head according to claim 14.

18. An ink jet recording apparatus comprising the ink jet head unit according to claim 15.

19. An ink jet recording apparatus comprising the ink jet head unit according to claim 16.

20. An ink jet recording apparatus comprising the ink jet head unit according to claim 17.
